(19) United States
(12) Patent Application Publication
(10) Pub. No.: US 2008/0072493 A1
(43) Pub. Date: Mar. 27, 2008

(54) MOULD FOR PREVENTING WATER ACCUMULATION IN FLOWER POTS

(75) Inventor: Peter Pfister, Goldiwil (CH)

Correspondence Address: ROBERTS, MLOTKOWSKI & HOBBES, P. O. BOX 10064, MCLEAN, VA, 22102-8064, US

(73) Assignee: Alrun Obermeier, Rothwesten (DE)

(21) Appl. No.: 11/469,973

(22) Filed: Sep. 5, 2006

(51) Int. Cl. A01G 25/00

(52) U.S. Cl. 47/80

(57) ABSTRACT

This invention refers to a mold for use on the bottoms of flower pots, characterized in that the mold has a height of at least 5% of the height of the flower pot and its top side has a surface area, which, when in use, is at least 25% of the cross-sectional surface area of the flower pot at the level of its top side, and it refers to the use of such a mold in a flower pot to prevent accumulations of water and excessive moisture in the root area and to a flower pot in which such a mold is integrated.

### RELATED APPLICATIONS

This applications claims priority to German Patent Application No. 10 2005 041 7987.3, filed on Sep. 2, 2005, which is hereby incorporated by reference.

### FIELD OF THE INVENTION

This invention concerns a mold for preventing water accumulation in flower pots, particularly in flower pots with cultivated soil or related soil-like substrata.

### BACKGROUND OF THE INVENTION

Due to the frequent accumulation of water in the lower portion of flower pots, which occurs, for example, as the result of pouring water into the saucer under the flower pot or as a result of too frequent watering, roots develop in the bottom of the pot when plants are cultivated in such pots. If the user continues to pour water into the saucer, the roots, particularly the fine roots, begin to rot and become damaged in the standing water. Since it is the fine roots of plants that absorb the water, the plant can no longer absorb sufficient water. This results in signs of damage on the above-ground parts of plants, such as wilting, which in turn motivates the user to water the plants even more to remedy the plant's seeming lack of water. The result is that the damage to the roots is accelerated, which can cause the death of the entire plant.

It is well known that pottery shards from old flower pots, expanded clay from hydroponics, various kinds of gravel, etc. can be spread on the bottom of the pot in an effort to prevent water accumulation and allow better drainage. However, this measure does not prevent water accumulation and the fine roots are not prevented from entering the zone filled with standing water. The drain holes also become clogged by the felt on the roots and the soil and substrata particles that have washed loose.

It is also common to provide a water reservoir on the bottom of the flower pot. To this end, a sort of “double bottom” is used in order to be able to supply the volume of roots with water over a long period of time. The water reservoir is covered as far up as the roots by a perforated cover. This shape from EP 1 339 275 B1 corresponds to U.S. Pat. No. 7,000,351 is common. It shows a mold that extends across a preferably conical hump into the interior of the flower pot. At the hump's highest point, there are openings that allow water or air to pass from the inside of the mold to the outside into the plant's substrata. Even the use of such a water reservoir does not prevent water accumulations, because the fine roots can extend unimpeded into the zone filled with standing water. Here too, the drain holes become clogged by the felt on the roots and the soil and substrata particles that have washed loose.

The task at hand therefore was to provide a device that prevents the accumulation of water in potted plants with soil or soil-like substrata thereby eliminating damage to the plant caused by improper watering on the part of the user.

### SUMMARY OF THE INVENTION

The underlying basis of this invention is the realization that the afore-mentioned tasks can be solved by a mold that displaces at least a large part of the volume of the substrata on the bottom of the flower pot where the water accumulations can form, ensuring that no roots can enter this area.

This invention therefore provides a mold for use on the bottom of flower pots, which is characterized in that its height is at least 5% of the height of the flower pot and the surface area of its top side, when in use, is at least 25% of the cross-sectional surface area of the flower pot at the level of the top side.

This mold, as it was invented, ensures that no roots or only a very small number of roots can form in an area of the substrata that is a potential spot for water accumulation. In this way, the afore-mentioned negative consequences, such as damage to the roots and ultimately the plant itself, can be prevented even if the user improperly waters the plants.

The term “height of the mold” is understood to mean the dimension from the lowermost edge of the mold by means of which the mold lies on the bottom of the flower pot, to the lowermost point of the top side, where an optional infeed on the upper outside of the mold is not considered part of the top side.

Preferably, the height of the mold is at least 8%, or even better, at least 10%, and best of all at least 12% of the height of the flower pot.

Irrespective of the height of the flower pot, the preferred height of the mold will be at least 0.3 cm, or even better, at least 0.5 cm and, best of all, at least 0.7 cm.

In the preferred version, the mold is intended for use in a flower pot which has an accompanying saucer. Preferably, when in use, it will then be high enough that its top side will be on nearly the same level as the upper edge of the saucer or higher or, best of all, on the same level as the upper edge of the saucer.

This version ensures that no water accumulation zone can form above the mold in the substrata of the flower pot because the water would run out over the edge of the saucer.

The maximum height of the mold is essentially determined by the fact that the mold occupies a volume in the flower pot in which no substrata, and therefore no nutrient solution exists for the plant. The volume of the mold should therefore be kept at a minimum.

Preferably, the height of the mold is at most 30%, or better still, at most 25%, and best of all at most 20% of the height of the flower pot.

Irrespective of the type of flower pot, the height of the mold will preferably be a maximum of 5 cm, or better still, a maximum of 3.5 cm.

Preferably, the mold should also help to ensure a continuous, uniform supply of water to the plant even if the user waters the plant at irregular intervals. In its preferred design, the mold is therefore highly porous, which gives it a high capacity for absorbing or giving off water. Preferably, the porosity will be at least 15%.

The porosity of the mold acts as a water regulator, which provides a continuous, uniform supply of water to the plant, even when watering is irregular, because the excess water is at least partially absorbed, stored and then slowly released again to the plant. In addition, the porosity of the mold guarantees that the mold continues to function over a long period of time and it also allows oxygen to reach the ball of roots.

Porosity is seen as the water absorption expressed as a percentage relative to the mold's own weight.

A more preferable version would be a mold consisting of a highly porous material with a porosity of at least 20%, or, better still, at least 25%, or, better still, at least 30% or 40%, and, best of all, at least 45

As raw materials for the mold, it is preferable to use highly capillary minerals, which are then displaced by and mixed with normal porosity-determining agents. The mixture is then molded and fired, which results in a porous mold. Organic raw materials, such as reeds or coco, can also be used as the basis for the mold.

Preferably, the mold will consist of clay or a clay-like material.

In one preferred design, when in use, the top side of the mold essentially runs parallel to the bottom of the flower pot.

For the purpose of enhancing its consumer appeal, the top side of the mold can also have an other than smooth surface even in this design by imprinting patterns onto its surface, however the height differences in the mold caused by the patterns comprise a maximum of 10% and preferably a maximum of 5% of the total height of the mold. Providing the top side of the mold with a pattern has no effect on its function.

In its preferred design, the mold has a recess on its underside which forms a reservoir for the water.

This design further contributes to improving the continuous supply of water to the plant even when watering is done at irregular intervals.

Preferably, the recess will have a height of at least 10%, better still, at least 20% of the total height of the mold.

The height of the recess preferably amounts to a maximum of 50%, better still, a maximum of 40% of the total height of the mold.

The size of the cross-section of the recess preferably amounts to at least 50%, better still, 60% and best of all, at least 75% of the total cross-section of the mold.

Better still, the mold will have orifices on its bottom edge which allow water to be exchanged with the recess.

In an even more preferred design, the top side of the mold has a surface, which, when in use, amounts to at least 35%, better still, at least 50% or 55%, and best of all 60% of the cross-sectional area of the flower pot on the level of the top side.

Irrespective of the cross-sectional area of the flower pot on the level of the top side of the mold, the top side of the mold will preferably have an area of at least 10 cm², better still, at least 13 cm², and best of all, at least 16 cm².

Preferably, the mold will have a shape, which, when in use, leaves a narrow margin open to allow water to penetrate unimpeded to the bottom of the flower pot

Therefore, the top side of the mold preferably has an area, which when in use amounts to a maximum of 95%, better still, a maximum of 90%, or, best of all, 80% of the cross-sectional area of the flower pot on the level of the top side

The area of the bottom side of the mold will preferably be larger than the area of the drain-hole in the bottom of the flower pot in which the mold is used.

More preferably, when in use, the area of the bottom side of the mold will amount to at least 70%, better still, at least 80%, and, best of all, at least 90% of the total inner area of the bottom of the flower pot.

More preferably, when in use, the area of the bottom side of the mold will amount to a maximum of 99% or, better still, a maximum of 96% of the total inner area of the bottom of the flower pot.

In principle, the cross-section of the mold can be of any geometric shape. Preferably however, the mold will have a round or multi-edged cross-section, preferably with regular multiple edges, better still with a circular, square or hexagonal cross-section.

It is also preferable if the mold has the same geometric shape as the flower pot.

In one preferred design, the mold has an infeed on its upper outer edge, which allows the remaining top side to be inserted into the recess of a second mold thereby allowing several molds to be easily stacked.

Preferably, the radial dimension of the infeed will be a maximum of 10% of the total diameter of the mold and the axial dimension of the infeed will be a maximum of 20% of the total height of the mold.

This invention also concerns the use of a mold in a flower pot (in one of the designs described above) for the purpose of preventing water accumulations and excessive moisture in the root area.

The mold in accordance with the present invention is used in such a manner that the mold is placed on the bottom of the pot above the drain-hole prior to filling the pot with soil or soil-like substrata. Any empty space between the inside of the flower pot and the outside of the mold is then filled with substrata, followed by the plant and the remainder of the substrata.

It is possible to use only one mold in a flower pot for flower pots with a circular cross-section, for example. It is also possible, however, to use several molds in one flower pot, e.g. several molds with a round or multi-edged cross-section in a flower pot with a rectangular cross-section.

It is also possible to directly integrate a mold in one of the designs described above into a flower pot. Therefore this invention also refers to a flower pot in which a mold from one of the designs described above is integrated.

### BRIEF DESCRIPTION OF THE DRAWINGS

This mold, in accordance with the invention, is further explained in the following examples in reference to the attached drawings.

These show:

FIG. 1 A perspective view of one design of this mold having a circular cross-section, in which the hidden contours are represented by dashed lines.

FIG. 2 A cross-section through the mold having a circular cross-section when in use in a flower pot that also has a circular cross-section along with the accompanying saucer.

FIG. 3 A cross-section through the mold having a circular cross-section when in use in a flower pot that also has a circular cross-section along with the accompanying planter.

FIG. 4 Plan view of a flower pot having a circular cross-section with an inserted mold that also has a circular cross-section (FIG. 4a) or a hexagonal cross-section (FIG. 4b).

FIG. 5 Plan view of a flower pot having a rectangular cross-section with inserted molds that have a circular cross-section (FIG. 5a) or a hexagonal cross-section (FIG. 5b).

FIG. 6 Perspective view of a mold design having a hexagonal cross-section.

FIG. 7 Longitudinal section of a flower pot with an integrated mold.

### DETAILED DESCRIPTION OF THE INVENTION

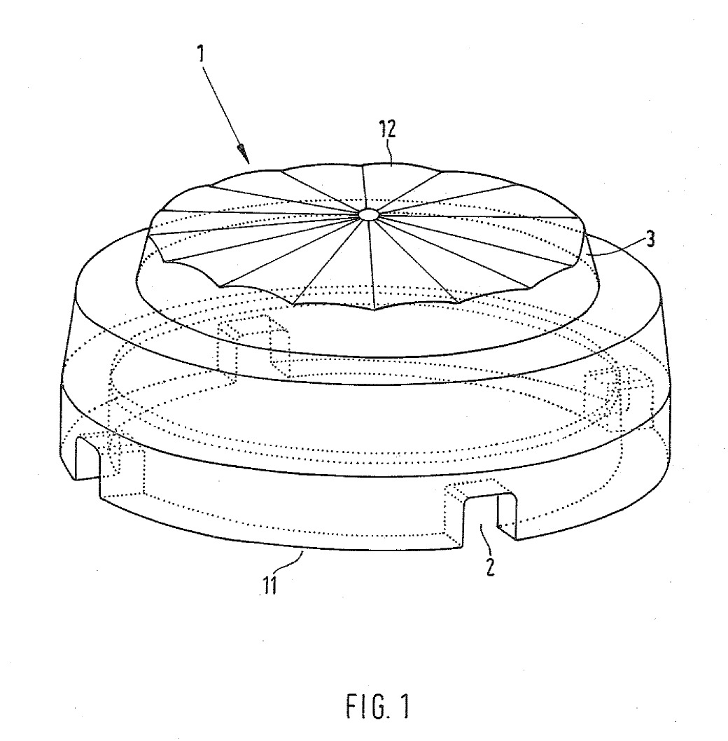

One design example of the mold (1) having a circular cross-section for use in a flower pot having a circular cross-section and a height of 10 cm is shown in FIG. 1.

The mold (1) also has a circular cross-section. It has a height of 1.7 cm and its diameter at its bottom edge is 9.2 cm, as opposed to the 9.5 cm inside diameter of the bottom surface area of the flower pot (corresponding to 97%), meaning that the mold, when in use, covers almost the entire surface area of the bottom of the flower pot (approx. 94%).

On its top side, the mold has an infeed (3), which extends radially approximately 0.6 cm and axially approximately 0.4 cm. The top side of the mold (without the infeed (3)) has a diameter of 8 cm, which results in a surface area for the top side of the mold of 50.3 cm², where 62% of the inside surface area of the flower pot at the level of the top side of the mold is reached.

Furthermore, on its underside, the mold has a recess (11), which has a height of 0.6 cm and a diameter of approximately 85% of the total diameter of the mold at the same height level.

The edge that results from the recess has a total of four orifices (2) through which water can penetrate.

The top side (12) of the mold has a visually appealing wave pattern.

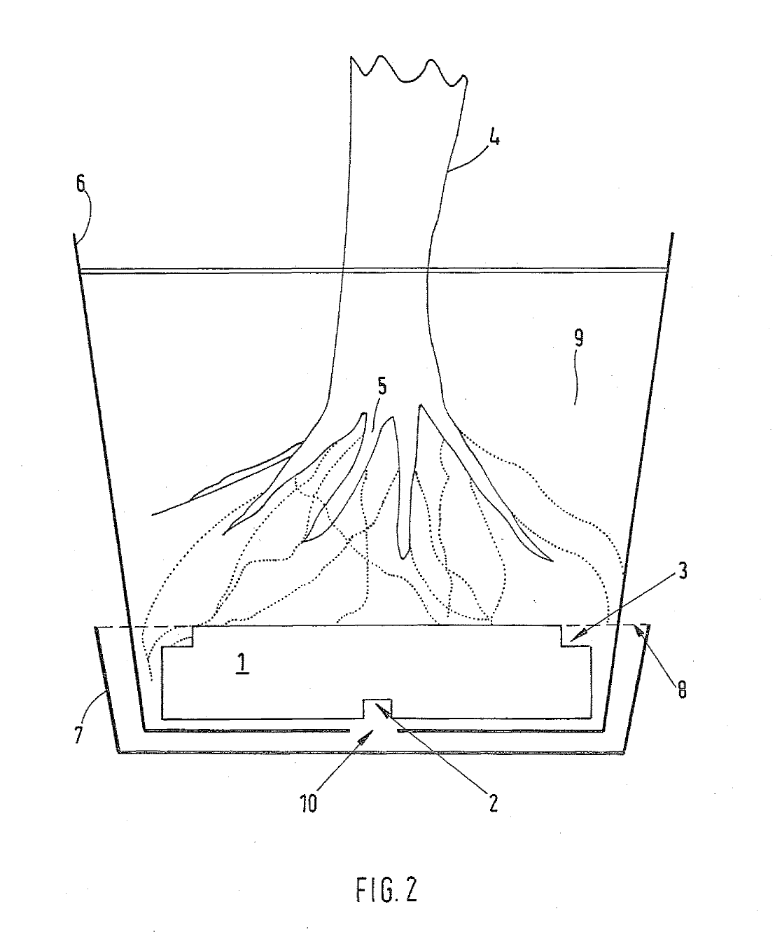

In FIG. 2, the mold (1) from FIG. 1 is shown in use in a flower pot (6) along with its accompanying saucer (7). The mold is arranged symmetrically over the drain-hole (10) of the flower pot (6). Furthermore it must be noted that the top side of the mold is at the same level as the upper edge of the saucer, which means that even when the saucer (8) is completely filled, only a minimal water accumulation zone can form and the roots (5) of the plant (4) that are in the substrata (9) cannot be endangered by accumulations of water, regardless of the watering habits of the user.

The water reservoir of the mold can be filled via the orifices (2).

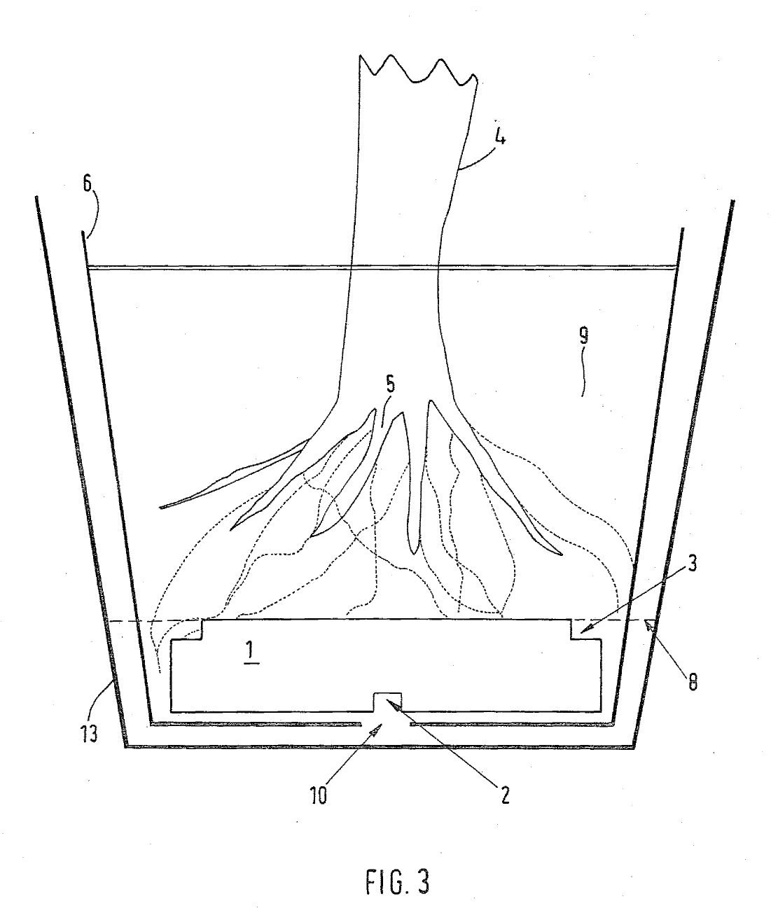

FIG. 3 shows the same mold as in FIGS. 1 and 2 when used in a flower pot that has a planter (13) but no saucer. In this case, to reliably prevent accumulations of water, the user must check the filling level of the planter at least enough to ensure that it does not exceed the level of the mold. The height of the mold, however, ensures that such a water accumulation zone can only arise as the result of considerable over watering.

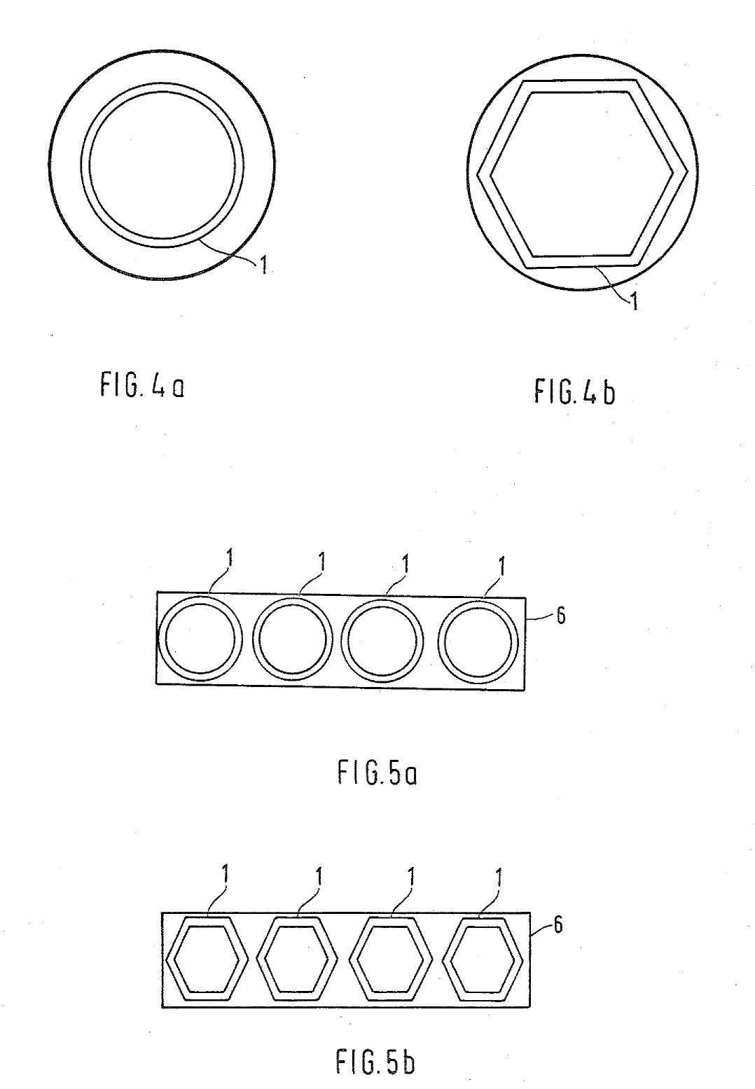

FIGS. 4 and 5 show possible mold arrangements with various cross-sections in various flower pots.

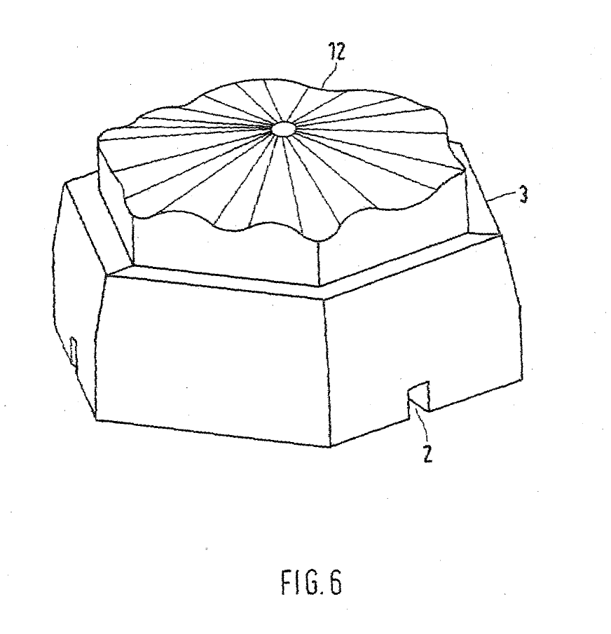

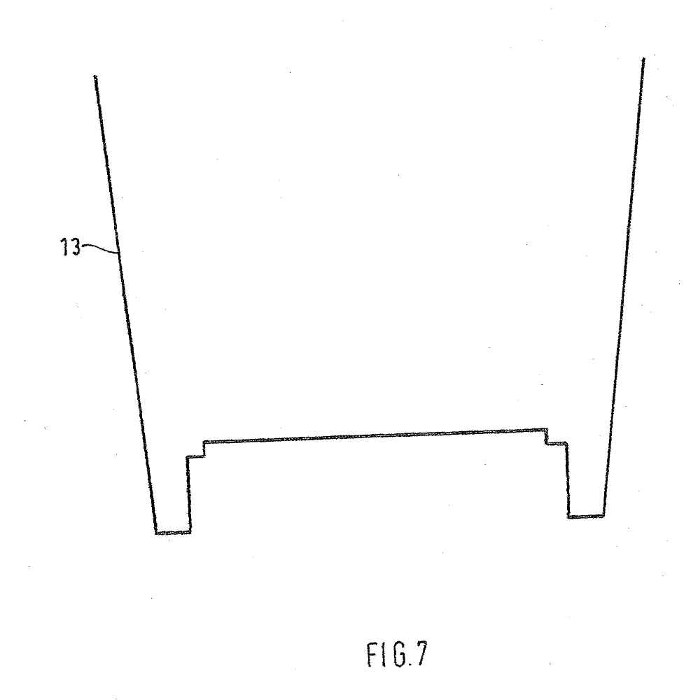

FIG. 6 shows a mold with a hexagonal cross-section, which has a top side (12), an infeed (3) and orifices (2) like the molds in FIG. 1. The mold also has dimensions similar to those of the mold in FIG. 1.

Finally, in FIG. 7, you can see a design of a mold that is integrated in a flower pot.

What is claimed is:

1. Molds for use on the bottoms of flower pots, characterized in that the mold has a height of at least 5% of the height of the flower pot and its top side has a surface area that, when in use, is at least 25% of the cross-sectional surface area of the flower pot at the level of the top side.

2. Mold as described in claim 1, characterized in that it has a height of at least 0.3 cm.

3. Mold as described in claim 1, characterized in that it is intended for use in a flower pot with an accompanying saucer and that its height is such that its top side, when in use, is on approximately the same or higher level as the upper edge of the saucer.

4. Mold as described in claim 3, characterized in that the height of the mold is such that its top side, when in use, is at approximately the same level as the upper edge of the saucer.

5. Mold as described in claim 1, characterized in that the mold has a height of a maximum of 30% of the height of the flower pot.

6. Mold as described in claim 1, characterized in that the mold has a height of a maximum of 5 cm.

7. Mold as described in claim 1, characterized in that its porosity is at least 15%.

8. Mold as described in claim 1, characterized in that its top side, when in use, runs essentially parallel to the bottom of the flower pot.

9. Mold as described in claim 1, characterized in that it has a recess on its underside which allows a water reservoir to form.

10. Mold as described in claim 1, characterized in that it has orifices on its lower edge, which allow the exchange of water with the recess.

11. Mold as described in claim 1, characterized in that, when it is in use, the surface area of its underside is at least 90% of the total surface area of the bottom of the flower pot.

12. Mold as described in claim 1, characterized in that its top side has a surface area that, when in use, is at least 50% of the cross-sectional surface area of the flower pot at the level of the top side.

13. Mold as described in claim 1, characterized in that it has an infeed on its upper outer edge, which allows the remaining top side to be inserted into the recess of a second mold thereby allowing several molds to be easily stacked.

14. Mold as described in claim 1, characterized in that it consists of clay or a clay-like material.

15. Use of a mold as described in any of the foregoing claims in a flower pot to prevent accumulations of water and excessive moisture in the root area.

16. Flower pot in which a mold as described in claims 1 to 14 is integrated.
